(19) United States
(12) Patent Application Publication
(10) Pub. No.: US 2005/0179689 A1
(43) Pub. Date: Aug. 18, 2005

(54) Information processing method and apparatus

(75) Inventor: Toshikazu Ohshima, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/054,745

(22) Filed: Feb. 10, 2005

(30) Foreign Application Priority Data
Feb. 13, 2004 (JP) 2004-036814

(51) Int. Cl. G06T 17/00; G06T 15/00

(52) U.S. Cl. 345/428

(57) ABSTRACT

An information processing method includes steps of: setting a parameter that is used in common with respect to a plurality of objects for changing levels of detail of a model in accordance with a user instruction; inputting information indicative of the size of a respective object; obtaining a distance between the position of a viewpoint and the position of the respective object; determining the level of detail of the model using the parameter, the information indicative of the size, and the distance; and rendering the object using a model corresponding to the determined level of detail.

### BACKGROUND OF THE INVENTION

1. Field of the Invention

The present invention relates to a method and apparatus for determining the level of detail of a model for use in rendering an object.

2. Description of the Related Art

In the field of three-dimensional computer graphics, a three-dimensional model is used to render an object. The three-dimensional model is constituted by a series of polygons. The larger the number of polygons constituting a three-dimensional model, the more similar to reality the three-dimensional model can be made. However, as the number of polygons increases, processing time also increases which lowers rendering speed.

The size of a three-dimensional figure that is displayed on a display device is now discussed below. As shown in FIG. 6, an image as viewed from a viewpoint 61 is projected on a projection surface 62. Accordingly, the size of a three-dimensional figure that is displayed on the display device is associated with a distance 64 between the viewpoint 61 and a three-dimensional target model 63. As the three-dimensional target model 63 is farther from the viewpoint 61, the three-dimensional figure displayed on the display device becomes smaller, so that it becomes unnecessary to generate a detailed three-dimensional model. Therefore, there is a method of using different three-dimensional models for rendering an object depending on the distances between the viewpoint and the three-dimensional target model.

In cases where a sphere 71 serving as an object is located near the viewpoint, as shown in FIG. 7, an area 72 displayed on the display device is large, so that it is necessary to generate a detailed three-dimensional model with small polygons constituting a sphere 73. On the other hand, in cases where the object, such as a sphere 74, is located far from the viewpoint, an area 75 displayed on the display device is small, so that a sphere 76 can be constituted by coarse polygons without impairing a sense of reality in human visual sensation.

This is generally known as an LOD (Level Of Detail) method. In the LOD method, levels are defined with respect to a positional relationship between a viewpoint and a three-dimensional target model, and three-dimensional models for use in rendering are changed according to the respective levels. With the LOD method used for rendering, a three-dimensional model can be realistically rendered at high speed.

In the conventional LOD method, the LOD is changed according to the distance between a viewpoint and a three-dimensional target model. In this case, it is necessary to manually set a distance with respect to every three-dimensional model (object). In cases where a user generates a virtual space using a great number of objects, the user must set a distance for controlling the LOD with respect to every object. This imposes a heavy burden on the user.

### SUMMARY OF THE INVENTION

In the present invention, the LOD is controlled using a parameter that is closely related to visual appearance as compared with a distance. Accordingly, the LOD can be controlled using the same parameter with respect to a plurality of objects. Thus, the present invention is directed to lessening a user's burden of setting a parameter for changing the LOD.

In one aspect of the present invention, an information processing method includes: setting a parameter that is used in common with respect to a plurality of objects for changing levels of detail of a model in accordance with a user instruction; inputting information indicative of a size of a respective object; obtaining a distance between a position of a viewpoint and a position of the respective object; determining a level of detail of the model based on the parameter, the information indicative of the size of the respective object, and the distance between the position of the viewpoint and the position of the respective object; and rendering the respective object using a model corresponding to the level of detail in the information determined.

In another aspect of the present invention, an information processing method for rendering an object using a model having a level of detail variable according to a relation between a position of a viewpoint and a position of the object includes: setting, as a control parameter for the level of detail, an angle that the object subtends as viewed from the position of the viewpoint; acquiring the position of the viewpoint; obtaining a distance between the position of the viewpoint and the position of the object; determining the level of detail based on the angle set as the control parameter and the distance between the position of the viewpoint and the position of the object; and rendering the object using a model corresponding to the level of detail determined.

Other features and advantages of the present invention will become apparent to those skilled in the art upon reading of the following detailed description of embodiments thereof when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating a display changing method using an angular factor according to an embodiment of the invention.

FIG. 2 is a diagram illustrating a display changing method using a distal factor according to the embodiment of the invention.

FIG. 3 is a flow chart illustrating processing procedures associated with setting of an LOD changing parameter according to the embodiment of the invention.

FIG. 4 is a diagram illustrating a user interface for setting the LOD changing parameter according to the embodiment of the invention.

FIG. 5 is a flow chart illustrating processing procedures for rendering an object using the LOD changing parameter according to the embodiment of the invention.

FIG. 6 is a diagram illustrating rendering of a three-dimensional figure in three-dimensional computer graphics.

FIG. 7 is a diagram illustrating a processing method using the LOD method.

### DETAILED DESCRIPTION OF THE EMBODIMENTS

Embodiments of the present invention will be described in detail below with reference to the drawings.

An angular factor or a distal factor can be used in a method for changing LODs (levels of detail) according to an embodiment of the present invention.

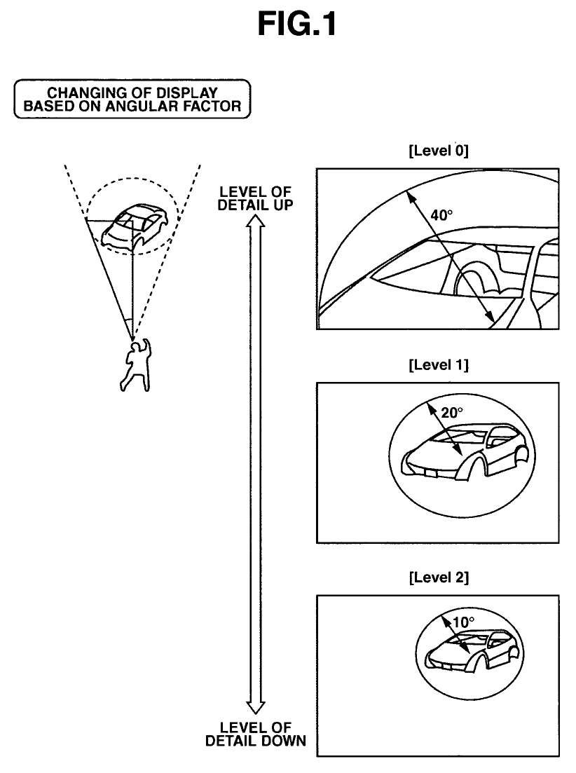

FIG. 1 is a diagram illustrating a method for changing LODs using the angular factor.

The angular factor represents an angle that a sphere enclosing an object subtends as viewed from a viewpoint. When the object is near the viewpoint, the value of the angular factor is large. When the object is far from the viewpoint, the value of the angular factor is small. A large object, as compared with a small object, makes the value of the angular factor large even if the large object is far from the viewpoint.

The fact that the angle of the object is large means that the object looks large from the current viewpoint. Thus, it is necessary to render the object in detail.

Accordingly, as the angle is larger, the LOD of the object should be heightened. For example, in the case of a car body shown in FIG. 1, the LOD is set to Level 0, Level 1 and Level 2 when the angle is 40 degrees, 20 degrees and 10 degrees, respectively. When the LOD is set to Level 0, the most detailed model file is displayed. The degree of display precision lowers as the LOD changes from Level 0 to Level 1 or from Level 1 to Level 2.

In the present embodiment, in order to process changing of LODs at high speed, an LOD changing parameter distance (d), which is a value associated with the angle, is used rather than the angle itself. The LOD changing parameter distance (d) is expressed by the following equation (1):
d=r/sin θ (1)

Using the angular factor (angle) allows LODs to be changed on the basis of the apparent size of an object. In addition, the LOD changing parameter distance (d) is calculated based on the size of an object. Accordingly, the user can set changing of appropriate LODs by setting the angular factor to the same value with respect to a plurality of objects. Therefore, the user's burden can be significantly reduced as compared with a conventional method in which it is necessary to set a distance with respect to every object.

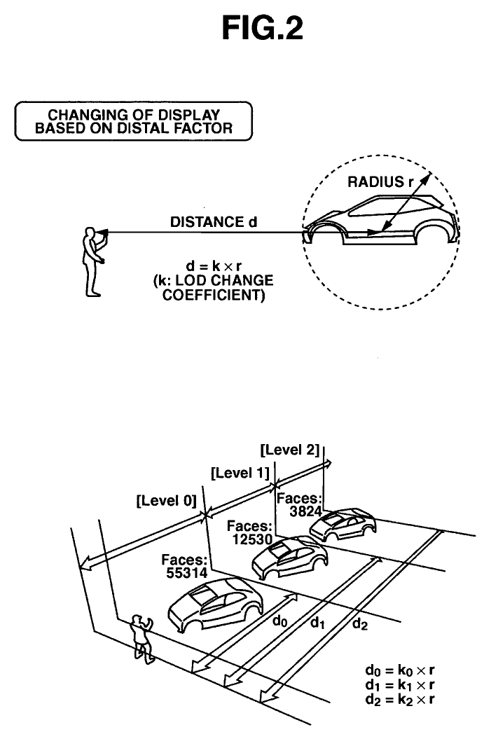

FIG. 2 is a diagram illustrating a method for changing LODs using the distal factor.

The distal factor is used to control changing of LODs based on the radius r of a sphere that encloses an object. The radius r represents the size of the object. A large object, as compared with a small object, is required to be rendered in detail even if the large object is far from a viewpoint.

In the distal factor, a distance for use in changing of LODs is obtained based on the radius r of an object. Accordingly, a suitable value for the object can be set.

An LOD changing parameter distance (d) in the distal factor is obtained from the following equation (2) using the radius r of a sphere that encloses an object and a coefficient k:
d=k×r (2)
The coefficient k is used to define to what times the radius r the value of the LOD changing parameter distance (d) is set.

In FIG. 2, a distance d between a point of view and an object is compared with a distance of an LOD changing parameter, and a level i of LOD is changed so that the distance d is smaller than a distance dᵢ corresponding to one level i of the LOD changing parameter and greater than a distance dᵢ₋₁ corresponding to another level i-1 of the LOD changing parameter.

Using the distal factor also allows LODs to be changed on the basis of the apparent size of an object. As in the case of the angular factor, the user can set the distal factor to the same value with respect to a plurality of objects.

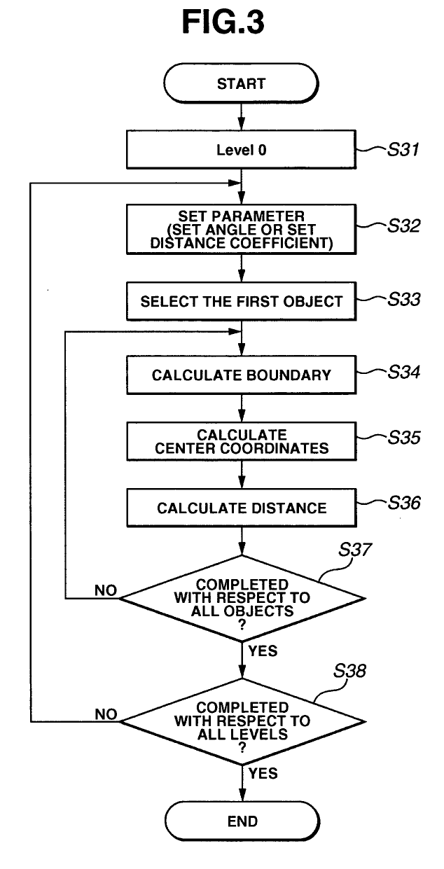

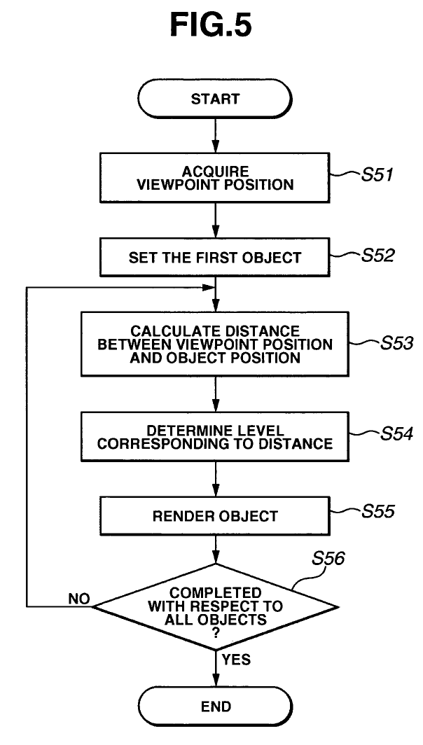

Procedures for calculating an LOD changing parameter and rendering an object based on the LOD changing parameter are described below with reference to FIGS. 3 to 5 according to the present embodiment. These procedures are implemented by a CPU (central processing unit) executing a program for performing the processes shown in FIGS. 3 and 5 using a memory.

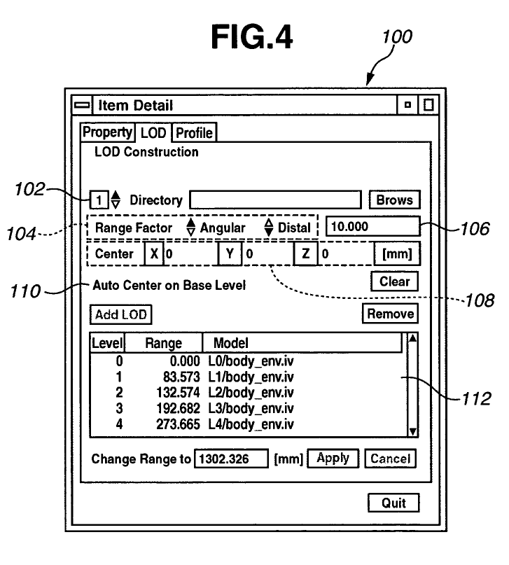

Procedures for setting the LOD changing parameter are first described with reference to FIGS. 3 and 4.

At step S31, Level 0 is set for initialization.

At step S32, the user selects an LOD changing method for changing LODs and sets a value associated with the selected LOD changing method, using a user interface 100 shown in FIG. 4.

In the user interface 100 shown in FIG. 4, an “LOD Level Selection Box” 102 is a box for setting the LOD value to set the following various conditions.

A “Range Factor Type Switch” 104 is a switch for selecting one of the angular factor described in FIG. 1 or the distal factor described in FIG. 2, as the LOD changing method.

A “Range Setting Field” 106 is a field for setting a value associated with the LOD changing method. If the angular factor is selected, the user inputs an angle (θ (degrees) in the equation (1)) into the “Range Setting Field” 106. If the distal factor is selected, the user inputs a coefficient (k in the equation (2)) into the “Range Setting Field” 106.

A “Center Coordinates Input Field” 108 is a field for inputting the center coordinates of an object. An “Auto Center Setting Switch” 110 is a switch for selecting a mode for automatically calculating and setting the center coordinates of an object. The method for automatically calculating and setting the center coordinates of an object is described in detail below with reference to steps S34 and S35.

An “LOD Content Display Area” 112 is an area for displaying a list of registered LODs.

At step S33, the first object is selected.

At step S34, the boundary of a target object is calculated. The boundary of an object represents a three-dimensional figure indicating the outline size of the object, for example, a hexahedron enclosing the whole object. The hexahedron can be obtained by sampling model data of a target object, detecting maximum values and minimum values on each of X-, Y- and Z-axes, and setting the detected values as lattice points of the hexahedron. The boundary may have another shape, for example, a sphere. In addition, the boundary may be calculated using another method.

At step S35, the center coordinates of an object are calculated. If the “Center Coordinates Input Field” has a value manually set by the user, the set value is read out. If the mode for automatically calculating and setting the center coordinates of an object is selected via the “Auto Center Setting Switch”, the center coordinates are obtained from the calculated boundary. In the present embodiment, since a hexahedron is used as the boundary, the center of diagonals of the hexahedron are set as the center coordinates. In addition, the length of one-half of the diagonal is set as the radius (r) of a sphere enclosing the object. More specifically, a sphere circumscribing the hexahedron serving as the boundary is supposed as a sphere enclosing an object shown in FIG. 1 or 2.

At step S36, a distance (d) is obtained using the radius (r) of a sphere enclosing the object obtained at step S35, a computing equation corresponding to the LOD changing method set at step S32, and a value associated with the set LOD changing method.

If the angular factor is selected, the distance (d) is obtained based on the equation (1) using the radius (r) and the angle (θ) set at step S32.

If the distal factor is selected, the distance (d) is obtained based on the equation (2) using the radius (r) and the coefficient (k) set at step S32.

Processes at steps S34 to S36 are repeatedly performed with respect to all the objects (step S37). Furthermore, processes at steps S32 to S37 are repeatedly performed with respect to all of the levels (step S38).

According to the procedures shown in FIG. 3, a distance (d) serving as the LOD changing parameter for every level can be set with respect to every object.

The user may check the result of setting of the LOD changing parameter via the screen of a display device and carry out an adjustment based on the result of checking. In addition, the user may carry out a fine adjustment independently with respect to every object depending on the result of checking. Moreover, a set of applicable LOD values may be varied with respect to various objects. For example, the same model may be used for a certain LOD value and larger LOD values of a particular object. Moreover, an object corresponding to a certain LOD value or larger LOD values may be prevented from being rendered.

Procedures for rendering a three-dimensional object using the set LOD changing parameter are described below with reference to FIG. 5. In the present embodiment, model data corresponding to every LOD value set with respect to every object are previously stored in a memory. These model data are used to render an object.

At step S51, the position of a viewpoint is acquired.

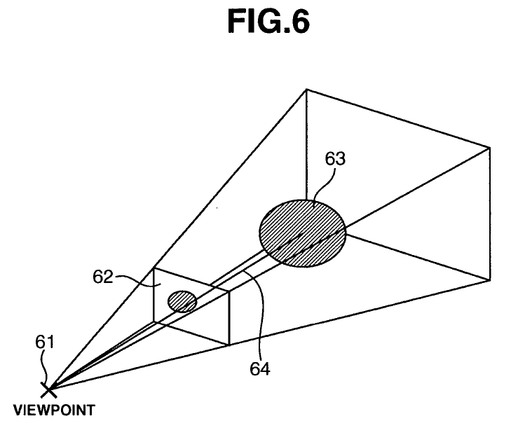

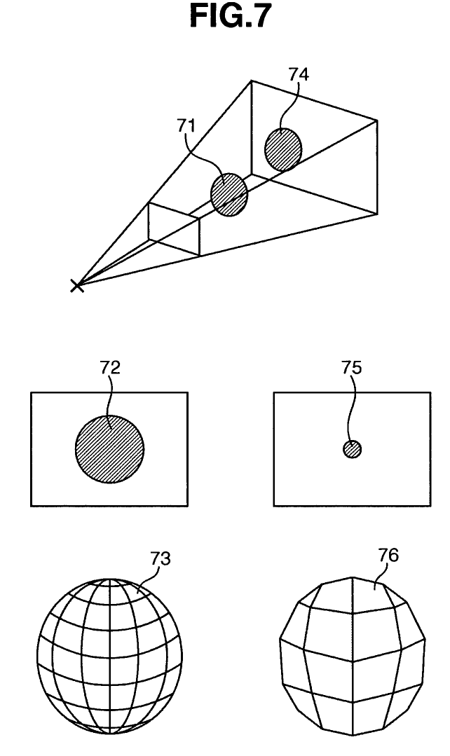

At step S52, objects required to obtain an image (corresponding to the projection surface shown in FIGS. 6 or 7) as viewed from the viewpoint position acquired at step S51 are selected, and the first object is set from among the required objects.

At step S53, the distance between the position of the viewpoint and the position of the object (the center coordinates of the object) is calculated.

At step S54, the distance obtained at step S53 is compared with the distance (d) serving as the LOD changing parameter corresponding to a target object obtained in the procedures shown in FIG. 3, and an LOD value corresponding to the distance obtained at step S53 is determined.

In the present embodiment, the distance (d) is used as the LOD changing parameter irrespective of the LOD changing method. Accordingly, processing at step S54 can be performed without regard to the LOD changing method. Therefore, the structure of a program for implementing procedures shown in FIG. 5 can be simplified.

Furthermore, in the present embodiment, the distance between the viewpoint position and the center coordinates of an object is used as a distance obtained at step S53. Accordingly, the LOD value can be set based on the apparent size of an object as viewed from the viewpoint rather than the apparent size of an object appearing on the image screen. Therefore, more natural rendering can be performed.

At step S55, a model of a target object corresponding to the LOD value determined at step S54 is read from the memory, and an image as viewed from the viewpoint position is generated.

Processes at steps S53 to S55 are repeatedly performed with respect to all the necessary objects (step S56), so that corresponding images as viewed from the viewpoint are generated.

While, in the above-described embodiment, two types of LOD changing methods are provided, only one of the two types may be provided. Alternatively, a conventional method of manually setting a distance with respect to every object may be provided in addition to the two types of LOD changing methods, i.e., three types of LOD changing methods may be provided.

Furthermore, while, in the above-described embodiment, the distance (d) is calculated at step S36 shown in FIG. 3, the distance (d) may be calculated in the process of each rendering shown in FIG. 5.

Moreover, the present embodiment is directed to processing for rendering an object. Accordingly, the present embodiment can be applied to a system for providing a virtual space constituted only by computer-generated images, or to a system for providing a mixed reality space obtained by combining real images and virtual images.

In addition, while, in the above-described embodiment, each process is implemented by software, the processes may also be implemented by hardware.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-036814 filed Feb. 13, 2004, which is hereby incorporated by reference herein.

1. An information processing method comprising:
setting a parameter that is used in common with respect to a plurality of objects for changing levels of detail of a model in accordance with a user instruction;
inputting information indicative of a size of a respective object;
obtaining a distance between a position of a viewpoint and a position of the respective object;
determining information comprising a level of detail of the model based on the parameter, the information indicative of the size of the respective object, and the distance between the position of the viewpoint and the position of the respective object; and
rendering the respective object using a model corresponding to the level of detail in the information determined.

2. An information processing method according to claim 1, wherein the parameter indicates an angle that the respective object subtends.

3. An information processing method according to claim 1, wherein the parameter is a coefficient to be multiplied by the information indicative of the size, and
wherein the level of detail is determined based on a result of comparison between the distance between the position of the viewpoint and the position of the respective object and a value obtained by multiplying the information indicative of the size by the parameter.

4. An information processing method according to claim 1, further comprising automatically obtaining the position of the respective object from a model of the object.

5. An information processing method according to claim 4, wherein automatically obtaining the position of the respective object from the model of the object comprises obtaining a boundary of the respective object from the model of the object, and obtaining the position of the respective object and the size of the respective object from the boundary of the respective object.

6. An information processing method according to claim 1, further comprising:
providing a plurality of level-of-detail changing methods; and
selecting, from the plurality of level-of-detail changing methods, a level-of-detail changing method corresponding to a user instruction,
wherein the parameter is a parameter corresponding to the level-of-detail changing method selected.

7. A program for causing a computer to perform the information processing method according to claim 1.

8. An information processing method for rendering an object using a model having a level of detail variable according to a relation between a position of a viewpoint and a position of the object, the information processing method comprising:
setting, as a control parameter for the level of detail, an angle that the object subtends as viewed from the position of the viewpoint;
acquiring the position of the viewpoint;
obtaining a distance between the position of the viewpoint and the position of the object;
determining the level of detail based on the angle set as the control parameter and the distance between the position of the viewpoint and the position of the object; and
rendering the object using a model corresponding to the level of detail determined.

9. A program for causing a computer to perform the information processing method according to claim 8.

10. An information processing apparatus comprising:
a setting unit configured to, in accordance with a user instruction, set a parameter that is used in common with respect to a plurality of objects for changing levels of detail of a model;
an input unit configured to input information indicative of the size of a respective object;
a distance obtaining unit configured to obtain a distance between the position of a viewpoint and the position of the respective object;
a determination unit configured to determine the level of detail of the model using the parameter set by the setting unit, the information indicative of the size of the respective object input by the input unit, and the distance between the position of the viewpoint and the position of the respective object obtained by the distance obtaining unit; and
a rendering unit configured to render the respective object using a model corresponding to the level of detail determined by the determination unit.
